(19) United States
(12) Patent Application Publication
(10) Pub. No.: US 2011/0116343 A1
(43) Pub. Date: May 19, 2011

(54) Positioning a Seismic Acquisition System Using Electromagnetic Signals

(76) Inventors: Halvor S. Groenaas, Oslo (NO); Svein Arne Frivik, Oslo (NO)

(21) Appl. No.: 12/606,981

(22) Filed: Oct. 27, 2009

(51) Int. Cl. G01V 1/38; G01V 1/20

(52) U.S. Cl. 367/19; 367/15; 367/16

(57) ABSTRACT

An apparatus includes a towed seismic acquisition system and a ranging system. The ranging system is adapted to use electromagnetic ranging signals to indicate a location of one or more points on the towed seismic acquisition system.

### BACKGROUND

The invention generally relates to positioning a seismic acquisition system using electromagnetic signals.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, an apparatus includes a towed seismic acquisition system and a ranging system. The ranging system is adapted to use electromagnetic ranging signals to indicate a location of one or more points on the towed seismic acquisition system.

In another embodiment of the invention, an apparatus includes a seabed-based seismic acquisition system and an electromagnetic positioning system. The electromagnetic positioning system communicates electromagnetic signals between the seabed-based seismic acquisition system and an autonomous underwater system to position the vehicle relative to the seabed-based seismic acquisition system.

In another embodiment of the invention, a technique includes towing a seismic acquisition system and using electromagnetic ranging signals to indicate a location of one or more points on the seismic acquisition system.

In another embodiment of the invention, a technique includes positioning an autonomous underwater vehicle near a node of a seabed-based seismic acquisition system. The technique includes controlling the positioning based at least in part on an electromagnetic signal communicated between the seabed-based seismic acquisition system and the autonomous underwater vehicle.

In another embodiment of the invention, a technique includes deploying a cable of a seabed-based seismic acquisition system and controlling the deployment based at least in part on electromagnetic signals communicated with antennas of the cable.

In yet another embodiment of the invention, an apparatus includes a cable of a seabed-based seismic acquisition system; antennas disposed along the cable; and a vessel. The vessel controls the deployment of the cable on a seabed based at least in part on electromagnetic signals communicated with the antennas.

Advantages and other features of the invention will become apparent from the following drawing, description and claims.

### BRIEF DESCRIPTION OF THE DRAWING

FIG. 1 is a schematic diagram of a towed seismic acquisition system according to an embodiment of the invention.

FIG. 2 is an illustration of maximum ranges for an electromagnetic wave communication in sea water as a function of frequency for different sea water conductances.

FIG. 3 is an illustration of refraction losses at a sea-air interface as a function of frequency for different conductivities.

FIG. 4 is an illustration of wavelengths versus frequency as a function of frequency for different conductivities.

FIG. 5 is a flow chart illustrating a technique to position a towed seismic acquisition system according to an embodiment of the invention.

FIGS. 6, 7, 8 and 9 are illustrations of towed seismic acquisition systems that use electromagnetic ranging signals to position the systems according to embodiments of the invention.

FIG. 10 is a schematic diagram of a system illustrating positioning of an underwater autonomous vehicle using electromagnetic signals according to an embodiment of the invention.

FIG. 11 is a flow chart depicting a technique to position an autonomous underwater vehicle according to an embodiment of the invention.

FIG. 12 is a schematic diagram of a system that positions a seabed cable using electromagnetic signaling according to an embodiment of the invention.

FIG. 13 is a flow chart depicting a technique to deploy a cable of a seabed-based seismic acquisition system according to an embodiment of the invention.

FIG. 14 is a schematic diagram of a system that uses electromagnetic ranging signals to position an electromagnetic source according to an embodiment of the invention.

### DETAILED DESCRIPTION

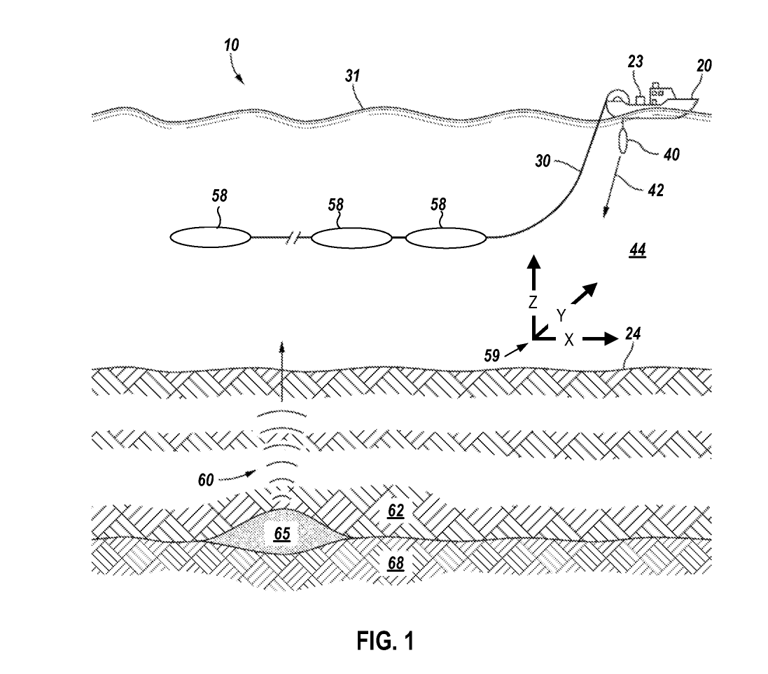

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. It is noted that the streamers 30 may be arranged in a spread in which multiple streamers 30 are towed in approximately the same plane at the same depth. As another non-limiting example, the streamers may be towed at multiple depths, such as in an over/under spread, for example.

The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors that record seismic signals. The streamers 30 contain seismic sensors 58, which may be, depending on the particular embodiment of the invention, hydrophones (as one non-limiting example) to acquire pressure data or multi-component sensors. For embodiments of the invention in which the sensors 58 are multi-component sensors (as another non-limiting example), each sensor is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more electromagnetic sensors, hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the sensor. It is noted that the multi-component seismic sensor may be implemented as a single device (as depicted in FIG. 1) or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes a seismic source 40, which may includes air gun elements and may be coupled to, or towed by, the survey vessel 20. Alternatively, in other embodiments of the invention, the seismic sources 40 may operate independently of the survey vessel 20, in that the source 40 may be coupled to other vessels or buoys, as just a few examples. It is noted that in FIG. 1, the seismic source 40 may be formed from several gun strings (air gun strings, for example), which may be fired in concert or independently at different times, as just a few examples.

As the seismic streamers 30 are towed behind the survey vessel 20, acoustic signals 42 (an exemplary acoustic signal 42 being depicted in FIG. 1), often referred to as “shots,” are produced by the seismic source 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary, or free surface 31.

The seismic sensors 58 generate signals (digital signals, for example), called “traces,” which indicate the acquired measurements of the pressure wavefield and particle motion. The traces are recorded and may be at least partially processed by a signal processing unit 23 that is deployed on the survey vessel 20, in accordance with some embodiments of the invention. For example, a particular seismic sensor 58 may provide a trace, which corresponds to a measure of a pressure wavefield by its hydrophone; and the sensor 58 may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system that may be, for example, located on land or on the vessel 20. Thus, many variations are possible and are within the scope of the appended claims.

For a marine seismic survey, one of the client deliverables is the positions of the seismic spread, including positions of the seismic source 20 and the positions of the streamers 30. The positions of the spread are important, as these positions provide the global reference to where the seismic traces are recorded and hence, the positions of where the final seismic image was acquired.

As a non-limiting example, the streamers 30 may be four to twelve kilometers long, and the seismic vessel 20 may tow between four to ten streamers 30, with streamer separation being from twenty-five to one hundred and fifty meters, depending on the scope of the survey. Each streamer 30 may have one or more global positioning satellite (GPS) receivers mounted on a front end and/or tail end surface float of the streamer 30 for purposes acquiring the streamer's global coordinates. In addition to GPS receivers, acoustic transmitters (called “pingers”) and acoustic receivers may be disposed on the streamer 30 for purposes of providing acoustic ranging. The acoustic ranging system provides ranges between several nodes and when combined with GPS-derived global position measurements, a positioning solution is provided, which may be used to position the streamers, though the use of vessel steering, streamer steering or a combination thereof.

The seismic source 40 may include three to eight gun stings (as non-limiting examples), and each gun string may have several airgun elements. Typically, the airgun elements are fired to produce a particular source signature. The airgun element in each gun string is not rigidly connected in the same way that different gun strings are not rigidly connected. Therefore, there is a dynamic component of separation between gun strings and gun elements.

For purposes of determining the correct signature of the seismic source 40, the gun string separation (GSS) as well as the relative positions between the airgun elements are monitored. This is especially important for a Calibrated Marine Source (CMS) technique, in which an estimation of the far field signature is made based on near field hydrophone measurements. For purposes of determining the global position of the source, a measurement called a Center of Source (CoS) may be used, which is the geometrical center of all of the gun strings based on nominal geometry and GPS measurements of gun string floats, given the buoyancy of the gun string. Acoustic pingers may be located on the gun strings (such as on the tail of each gun string) to determine the gun string separation.

The above-described acoustic ranging system may be faced with several challenges. More specifically, an acoustic ranging system in the vicinity of an active airgun has its performance reduced if the air from the previous shot is still present in the propagation path of the acoustic signal. Even very small quantities of air may have a significant impact on the speed of sound. Furthermore, air bubbles may scatter the signal due to scattering and absorption. Additionally, bubbles from propeller wash and turbulence from the vessel and towing operation further aggravates the problem.

In accordance with embodiments of the invention described herein, a seismic acquisition system uses electromagnetic signals for ranging signals for purposes of measuring various positions of the system. In general, the electromagnetic signals are less adversely affected by air bubbles in the area around the seismic source and also less susceptible to the presence of bubbles found in the vicinity of the sea surface that may otherwise limit the tie in between the GPS receivers on the surface and the acoustics at the gun level. As further described below the electromagnetic ranging signals may be used in lieu or in combination with other types of position location-type signals such as acoustic ranging signals and GPS signals.

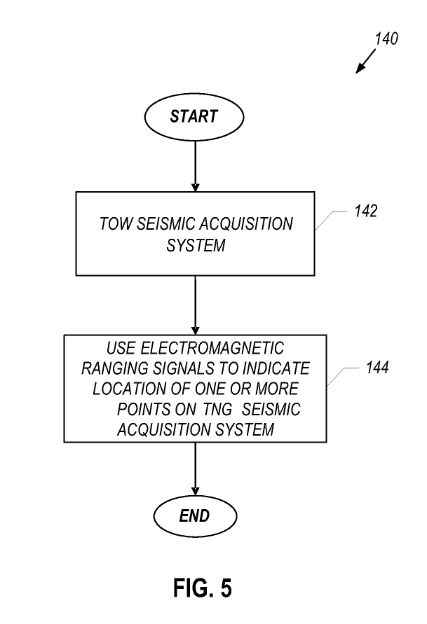

Thus, referring to FIG. 5, a technique 140 in accordance with embodiments of the invention includes towing (block 142) a seismic acquisition system and using (block 144) electromagnetic ranging signals to indicate a location of one or more points on the seismic acquisition system.

In accordance with some embodiments of the invention, the electromagnetic signals may be located in a radio frequency (RF) band from approximately 10 to 30 kiloHertz (kHz). However, in accordance with other embodiments of the invention, the electromagnetic signals may have frequencies in other RF bands. Thus, many variations are contemplated and are within the scope of the appended claims.

The electromagnetic signals may be used for purposes of location measuring purposes and thus, for purposes of positioning the seismic spread based on the following observations. Pure water is, in electromagnetic terms, an insulator. This means that, low frequency electromagnetic waves (also called “electromagnetic signals” interchangeably herein) can ideally travel relatively far distances in pure water. Water in its natural state, however, is a partial conductor due to ions from dissolved salts. Sea water typically has a conductivity around 4 Siemens per meter (S/m), which is about two orders of magnitude more than the conductivity of fresh water. Due to this conductivity, electromagnetic signals may be viewed as being inappropriate for use in sea water.

Therefore, for most communication purposes, electromagnetic signaling is not used in sea water due to the associated poor signal quality and low data rate. However, as described below, for purposes of ranging measurements using electromagnetic signals, the available signal quality and data rate are acceptable for ranging measurements and have the added benefit of being relatively insensitive (as compared to acoustic signals) to air bubbles, which may originate from the seismic source, the sea surface, the towing vessel, etc.

In general, electromagnetic signals have the following advantages to acoustic signals for ranging measurements. As compared to acoustic signals, electromagnetic signals have higher propagation speeds; are insensitive to Doppler shifts; have propagation speeds that are insensitive to pressure gradients; do not experience shadow zones; are immune to aerated water; and are more immune to multipath issues.

The properties of electromagnetic signals in seawater may be derived from Maxwell's equations for a conductor:

$$\begin{matrix}∇ \cdot E = \frac{1}{ɛ} {ρ}_{f} , & Eq . 1 \\ ∇ \cdot B = 0 , & Eq . 2 \\ ∇ \times B = μσ E + μɛ \frac{\partial E}{\partial t} , and & Eq . 3 \\ ∇ \times E = \frac{\partial B}{\partial t} , & Eq . 4\end{matrix}$$

where “E” represents the electric field; “B” represents the magnetic field; “ρ_{f}” represents free charge; “ε” represents the electrical permittivity; “σ” represents the conductance; and “μ” represents the magnetic permeability.

Typical permittivity values for sea water are ε=εᵣε₀=80ε₀ Farads/m, where ε₀ is the permittivity of free space. A typical value for magnetic permeability is μ=μᵣμ₀0.9999912ε₀ Henrys/m (H/m), where “μ₀” represents the permeability of free space. The conductance, σ, has a range of two to eight Siemens/m (S/m) in sea water, with values around four being by far the most common Values around eight are very uncommon and have only been reported in a few locations (an example is the Red Sea).

By applying the curl operator, as shown in Eqs. 3 and 4, the following relationships, which describe a wave motion for the electric and magnetic fields, may be obtained:

$$\begin{matrix}{∇}^{2} E = μɛ \frac{{\partial }^{2} E}{\partial {t}^{2}} + μσ \frac{\partial E}{\partial t} , and & Eq . 5 \\ {∇}^{2} B = μɛ \frac{{\partial }^{2} B}{\partial {t}^{2}} + μσ \frac{\partial B}{\partial t} . & Eq . 6\end{matrix}$$

For convenience, a plane wave solution is assumed. The solution to Eqs. 5 and 6, assumes a monochromatic plane wave that is traveling in the vertical (z) direction and polarized in the inline (x) direction, as described below:

\tilde{E}(z,t)=\tilde{E}₀e^{-k}^{ₓ}^{z}e^{(ikz-107 t)}, and) Eq. 7

B(z,t)=\tilde{B}₀e^{-k}^{ₓ}^{z}e^{(ikz-ωt)}. Eq. 8

The wave numbers set forth in Eqs. 7 and 8 are as follows:

\tilde{k}²=μεω²+iμσω, and Eq. 9

\tilde{k}=k+ik_{c}, Eq. 10

where the real (kᵣ) and complex (k_{c}) parts are described as follows:

$$\begin{matrix}{k}_{r} = ω {\sqrt{\frac{ɛμ}{2}} [ \sqrt{1 + {( \frac{σ}{ɛω} )}^{2} + 1} ]}^{1 / 2} , and & Eq . 11 \\ {k}_{x} = ω {\sqrt{\frac{ɛμ}{2}} [ \sqrt{1 + {( \frac{σ}{ɛω} )}^{2} - 1} ]}^{1 / 2} . & Eq . 12\end{matrix}$$

The complex part of the wave number reflects the absorption of energy due to conduction currents in the medium. Some fundamental quantities associated with the wave described above are as follows:

$$\begin{matrix}d ≡ \frac{1}{{k}_{c}} , & Eq . 13 \\ c = \frac{ω}{k} , & Eq . 14 \\ λ = \frac{2 π}{k} , and & Eq . 15 \\ n = \sqrt{\frac{ɛμ}{{ɛ}_{0} {μ}_{0}}} , & Eq . 16\end{matrix}$$

where “d” represents the skin depth; “c” represents the propagation speed; “λ” represents the wavelength; and “n” represents the refraction index of the medium.

There are several loss processes that affect the propagation of an electromagnetic wave in sea. In particular, absorption (primarily due to conduction currents) and geometric spreading (assumed spherical) are the primary propagation losses in sea; and specular reflection loss is the primary loss at the sea-air boundary. Scattering from ions and suspended particles is expected to be negligible due to the large wavelengths of the electromagnetic waves.

Using the relationships that are set forth above, incorporating spherical spreading, and fixing the permeability and permittivity, the in-sea source-to-receiver transmission loss for an electromagnetic signal may be expressed in decibels as follows:

T(r,f,σ)=20(k_{c}r+log ₁₀(r)). Eq. 17

In the following discussion, the following characteristics of the notational antenna system are assumed: radiated power is 0 dBW; the receiver bandwidth is 4 kHz; the temperature is 293 Kelvin; the minimum discernible receiver level is −157 dBW; and the sensitivity is −154 dBW.

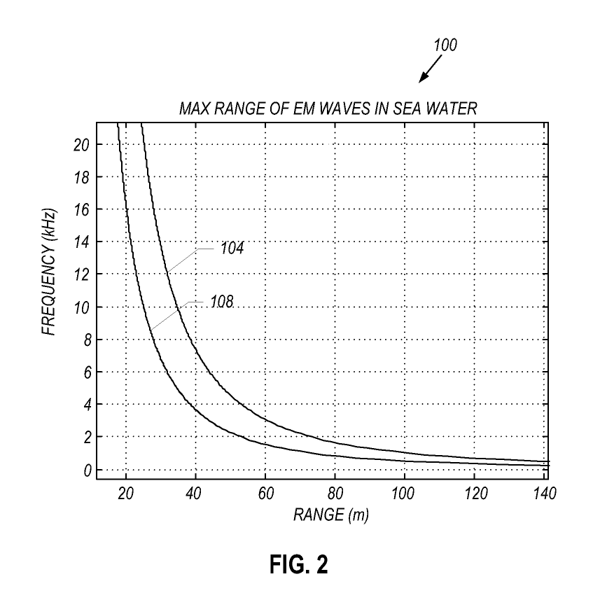

Using the above-described system as a basis and applying the transmission loss of Eq. 17, the maximum ranges for an electromagnetic signal versus frequency (f) for different conductivities (ρ) are depicted in FIG. 2. More specifically, FIG. 2 depicts the maximum range of an electromagnetic signal in sea water versus frequency for a sea water conductivity of 4 S/m: (graph 104) and a sea water conductivity of 8 S/m (graph 108). As shown, in general, the range decreases with the conductance and decreases with frequency.

The electromagnetic waves might propagate into the sea bed and potentially through the sea-air boundary as well. The sea bed typically displays wide ranges of conductivities, permittivities and permeabilities. In many cases, attenuation may be less in the sea bed than in the sea itself, thus representing an alternative propagation path. In all cases, a reflection loss occurs due to impedance differences at the boundaries.

Regarding the loss at the sea-air interface, there are two losses as the electromagnetic crosses the sea-air interface: a loss attributable to specular reflection due to the impedance difference between the two media; and a loss due to the diffusive reflection due to sea surface roughness. For the frequencies described herein, it is assumed that the second process is much smaller than the first and is ignored.

In the case of acoustics, the sea-air boundary is a pressure-release surface and thus, the reflection coefficient is close to one in absolute value, i.e., all of the energy is reflected. This is not the case, however, with the electromagnetic waves; and even though the reflection loss may be substantial, some energy may penetrate through to the free air.

The reflection loss for an electromagnetic wave, when crossing the sea-air boundary may be described as follows:

$$R ( f , σ ) = - 20 log ( 7.4586 \cdot {10}^{6} \cdot \sqrt{\frac{f}{σ}} ) . \qquad Eq . 18$$

The transmitted wave therefore seems to originate directly above the electromagnetic transmitter, is horizontally polarized and propagates almost parallel to the sea surface. The reason for this behavior can be seen from Eq. 16. In general, the refraction index of sea is approximately related to the refraction of air as follows: n sea≈\sqrt{80}nₐᵢᵣ. Therefore, based on Snells law, the refraction angle is large and only waves close to the normal incidence are below the critical angle.

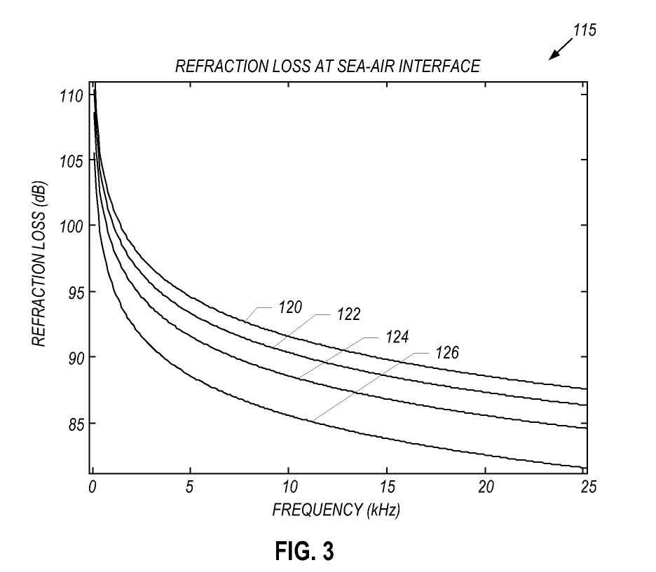

Referring to FIG. 3, an illustration 115 depicts the refraction losses of the sea-air interface versus frequency for different conductivities in graphs 120 (for a conductivity of 8), 122 (for a conductivity of 6), 124 (for a conductivity of 4) and 126 (for a conductivity of 2).

A conceivable challenge with the use of electromagnetic waves as ranging signals is that the electromagnetic waves may be able to penetrate the sea-air surface boundary, travel almost horizontally and then leak back into the sea. This leakage, in turn, may potentially clutter the direct arrival that is used for purposes of positioning. This should not be a problem, however, at the seismic source layer. More specifically, the signal used for ranging does not, in general, have sufficient power to last through a two layer transmission and reflection loss. By optimizing the frequency band so that the signal does not have power to penetrate back into the sea, the above-described problem may be avoided.

The wavelength of an electromagnetic signal when in the sea is much smaller than the wavelength of the electromagnetic signal when in free air. As an example, for a ten kilohertz (kHz) signal, the in sea wavelength at a conductance of four S/m is 15.8 meters, as contrasted to a wavelength of 30 kilometers in air. This means that relatively small antennas may be used in sea for purposes of communicating the electromagnetic ranging signals. A typical small loop antenna has a radius that ten to twenty times less than the signal wavelength.

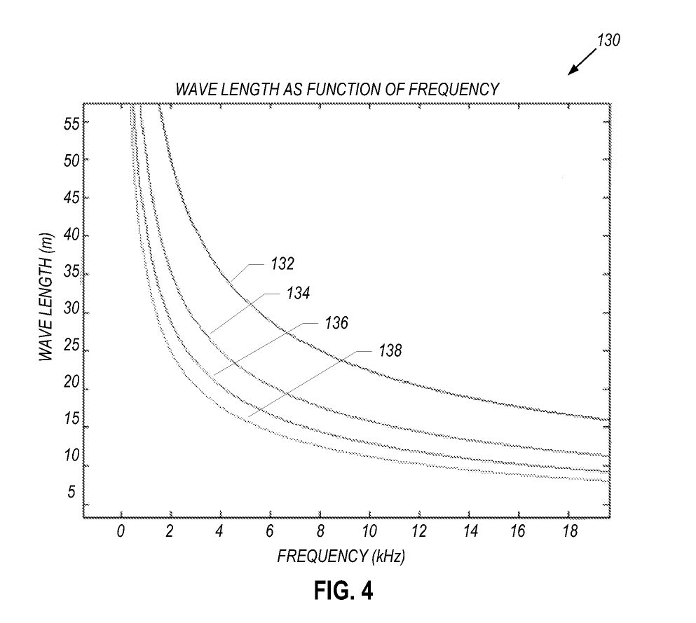

FIG. 4 is an illustration 130 of wavelengths versus frequency for different seq water conductivities: a graph 132 for a conductivity of two, a graph 134 for a conductivity of four, a graph 136 for a conductivity of six and a graph 138 for a conductivity of eight. It is noted that although or a combination of loop antennas are mentioned as possibilities for an antenna solution, in accordance with other embodiments of the invention, other antennas whether passive or active, may be used. Thus, many variations are contemplated and are within the scope of the appended claims.

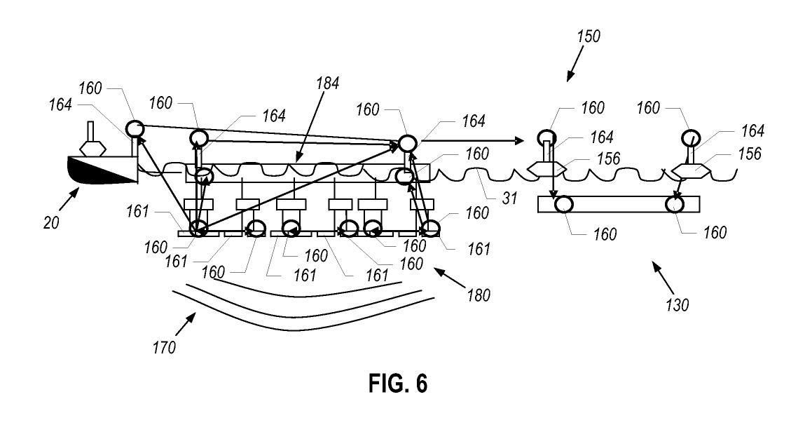

As an example, a system 150 that is depicted in FIG. 6 may use electromagnetic ranging signals in accordance with embodiments of the invention. In the system 150, the vessel 20 tows a seismic source and at least one streamer 30. The seismic source includes a float 184 that, as it name implies, floats on the sea surface 31 and gun elements 161 that hang beneath float 184. In general, the float 184 contains GPS receivers 164 that receive GPS signals through the air for purposes of acquiring the global position of the gun float 184. The gun elements 161 of the seismic source are not rigidly positioned next to each other, and further, hang in a non-rigid fashion below the float 184.

The gun layer, which is the layer containing the gun elements 161, contains various antennas 160 (depicted as loop antenna for this example), which are constructed to transmit and/or receive electromagnetic ranging signals to tie the gun level to the float 184. Each antenna 160 may be associated an electromagnetic wave transmitter, an electromagnetic wave receiver or an electromagnetic transceiver, depending on the particular embodiment of the invention.

In accordance with some embodiments of the invention, electromagnetic signals are communicated between the antennas 160 on the gun level to antennas 160 that are part of the float layer and are located above the air-sea surface 31. In other embodiments of the invention, the electromagnetic waves are communicated from the antennas 160 on the gun level to antennas that are located slightly below the sea surface 31 but still part of the float layer. In other embodiments of the invention, the electromagnetic waves may be communicated between antennas 160 on the gun string level and antennas 160 on the vessel 20.

In some embodiments of the invention, electromagnetic ranging signals may be communicated between antennas 160 on the seismic source and antennas 160 on the streamers 30. More specifically, in accordance with some embodiments of the invention, electromagnetic ranging signals may be communicated with antennas 160 on the streamers 30 for purposes of tying in the gun string level with the streamer spread. This may be accomplished by having antennas 160 on the gun or float level of the source communicate with antennas 160 on the streamers 30. As depicted in FIG. 6, the streamers 30 may also have antennas 160 that tie in the position of the streamer cable 30 with antennas 160 that are positioned on head end 154 and tail end 156 floats, which are connected to the head end and tail ends, respectively of the streamer 30 and float on the sea surface.

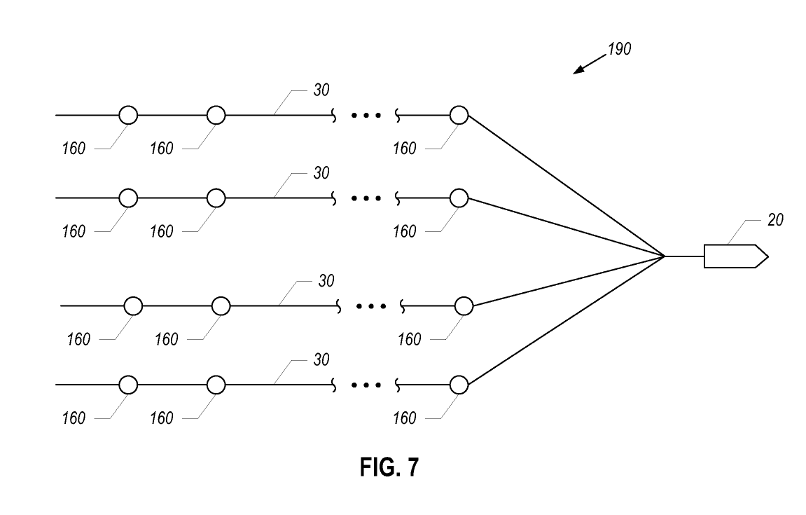

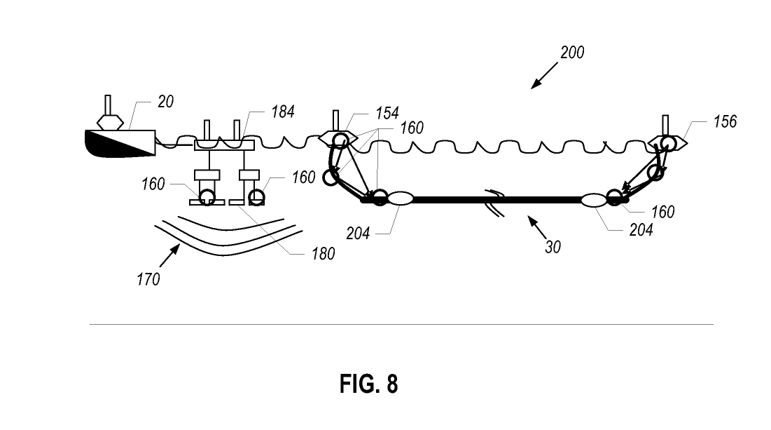

Referring to FIG. 7, in accordance with embodiments of the invention, a marine seismic acquisition system 190 may distribute antennas 160 long the length of each streamer 30 of the system 190 for purposes of performing electromagnetic signal-based ranging along the length of each streamer 30. Each antenna 160 may be associated with a particular electromagnetic transmitter, receiver and/or transceiver. Due to the relatively short range of electromagnetic signals in sea, it may be relatively difficult to position the streamers without applying a high number of closely-spaced antenna 160 along the streamers 30 for purposes of an electromagnetic signal only-based ranging system. Therefore, in other embodiments of the invention, the streamers 30 may have fewer antennas 160 to transmit electromagnetic signals to tie in each streamer 30 to the seismic streamer floats 154 and 156, while employing acoustic receivers and/or transmitters, in general, along the length of each streamer 30. This arrangement is illustrated in FIG. 8 for a seismic acquisition system 200.

More particularly, referring to FIG. 8, in a seismic acquisition system 200, a particular streamer 30 may include acoustic nodes 204, which are associated with acoustic transmitters and receivers for establishing an acoustic ranging system between streamers 30 (in a crossline direction) as well as along the length of the streamer 30. For purposes of tying in these local positions to the head end 154 and tail end 156 floats, antennas 160 that are located on the streamer 30 and floats 154 and 156 communicate using electromagnetic signals for purposes of measuring the distances between the streamer and float positions. Thus, this arrangement improves the global position accuracy and provides high fidelity position estimates. If the distances between the cable and GPS antennas 160 become too large, a plurality of antennas 160 may be used to repeat the electromagnetic signals in order to cover the larger distances.

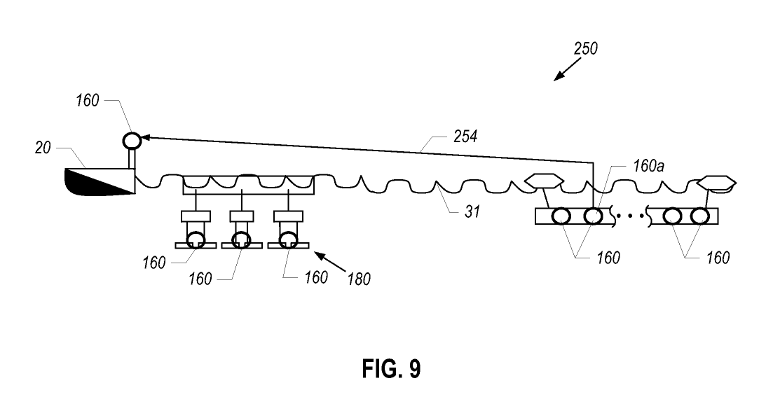

In accordance with some embodiments of the invention, electromagnetic signals may be directly used for purposes of positioning the seismic spread. In this regard, referring to a seismic acquisition system 250 depicted in FIG. 9, the sea-air propagation channel may be used to position the spread directly. The system 250 includes an array of antennas 160 on the vessel 20 (one antenna 160 of the array being depicted), which communicates directly with antennas 160 positioned on the source strings and streamers 30. As depicted in an exemplary sea-air propagation path 254, an antenna 160a may transmit an electromagnetic signal that propagates through the sea water to the sea surface 31, reaches the air and then travels in a general horizontal direction toward the antenna array on the vessel 20.

By mounting the array of antennas on the back deck of the vessel 20, the arrival directions of the incoming electromagnetic waves may be pinpointed very precisely. Furthermore, the signals may be made separable using such separation technology as spread spectrum sequences. Therefore, the position of every electromagnetic wave transmitter may be estimated by using a geometric model of the propagation path together with frequency and phase information of the incoming signals. In this case, higher frequency electromagnetic waves may be used, as the propagation distance to the sea surface is quite small, and higher frequency signals penetrate the surface with more energy in tact.

Because the antennas 160 on the vessel 20 receive the electromagnetic signals through the air, the antenna sizes on the vessel 20 may be significantly larger than the antennas 160 located below the sea surface. Therefore, active antennas may be used, in lieu of passive antennas, for the antenna array that is mounted to the vessel 20. For example, a particular active antenna may use a resonance circuit that is tuned to the carrier frequency of the signals. Alternatively, the capacitive reactants of a tuning capacitor may be used to balance the inductive reactants of the antenna and also the real resistance of the antenna by introducing a negative resistance using positive feedback. These are just two examples, as many other designs and structures for the antennas are contemplated and are within the scope of the appended claims.

In accordance with other embodiments of the invention, the same signal may not be used both above and below the sea-air surface. In this regard, in accordance with some embodiments of the invention, relatively higher frequency signals (MHz signals, for example) may be communicated above the sea surface for purposes of positions, such as electromagnetic signals that propagate between antennas on the vessel, the float, streamers, gun floats, etc.; and relatively lower frequency signals (sub MHz signals, for example) may be communicated below the sea-air surface. Thus, many variations are contemplated and are within the scope of the appended claims.

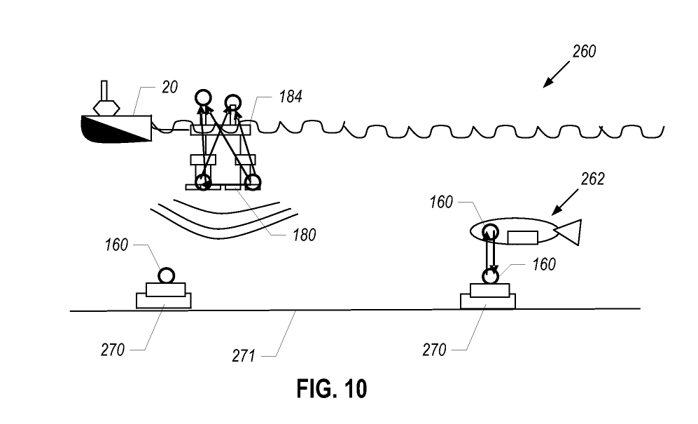

Referring to FIG. 10, in accordance with some embodiments of the invention, electromagnetic signals may be used for other purposes, such as for purposes of positioning an autonomous underwater vehicle (AUV) 262 and communicating acquired seismic data with the AUV 262.

More specifically, in a typical seabed seismic acquisition system, nodes that are deployed on the seabed typically have to be retrieved to the surface for purposes of retrieving the stored acquired seismic data. Such an approach, however, may be time consuming, expensive and introduce re-position-related inaccuracies for time lapse analysis. Instead of such approach, however, a seabed seismic acquisition system 260 that is depicted in FIG. 10 includes seabed nodes 270 that are connected to a seabed cable 271 and interrogated on place at the seabed by the AUV 262. In this manner, the AUV 262 approaches each node 270, remotely downloads the acquired seismic data from the node 270, and continues to the next node 270 for purposes of repeating this process until all of the seismic data are downloaded. The AUV 262 may then travel back to the surface or communicate with a surface platform for purposes of transferring the data.

As depicted in FIG. 10, the AUV 262 includes an antenna 160 for purposes of transmitting and receiving electromagnetic signals that are transmitted to and received from a corresponding antenna 160 on each node 270. The AUV 262 and each node 270, in turn, includes a corresponding electromagnetic wave transceiver.

The AUV 262 approaches and downloads data from a particular node 270 in the following manner. First, the AUV 262 is positioned as close as possible to the node 270 without having to physically dock to the node 270. This avoids the risk of changing the coupling of the node 270 to the seabed. It is noted that change in the coupling may change the response of the time lapse signal. By communicating electromagnetic waves between the node 270 and the AUV 262, the AUV 262 may be precisely positioned closely to the node 262 for the second step. The second step involves communicating the acquired seismic data from the node 270 to the AUV 262 over a relatively high speed data communication link. Because the distance is relatively short (under a few meters, for example), the link has a high capacity and thus, the data is downloaded quickly from the node 270 to the AUV 262. The link is based on the same electromagnetic principles as the above-described electromagnetic signal, based positioning system. This approach has relatively power consumption, as compared to the approach using an acoustic modem; has a higher capacity than an acoustic channel; and is not vulnerable to Doppler properties and ray bending.

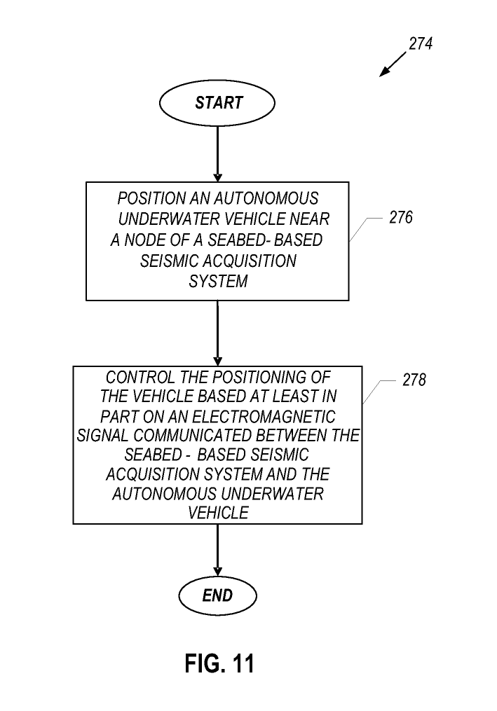

Thus, referring to FIG. 11, in accordance with an embodiment of the invention, a technique 274 includes positioning (block 276) an autonomous underwater vehicle near a node of a seabed-based seismic acquisition system and controlling (block 278) the positioning based at least in part on an electromagnetic signal communicated between the seabed-based seismic acquisition system and the autonomous underwater vehicle.

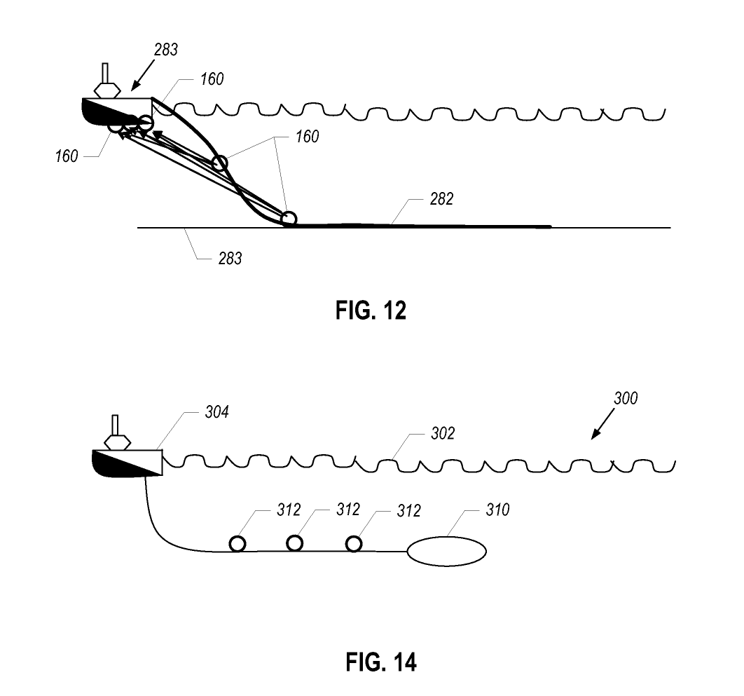

Electromagnetic waves may also be used in sea for purposes of controlling the deployment of a seabed cable. As a more specific example, FIG. 12 depicts a system 280 for deploying a seabed cable 282 on a seabed 283 according to an embodiment of the invention. As such, in general, the vessel 283 deploys the seabed cable 282 and the vessel 283 includes antennas 160 that communicate with antennas 160 that are distributed along the length of the seabed cable 282. In accordance with embodiments of the invention, each antenna 160 of the seabed cable 282 may be driven by an associated electromagnetic transmitter (not shown); and in general, the antennas 160 on the vessel 283 may furnish indications of the received electromagnetic signals to an onboard receiver.

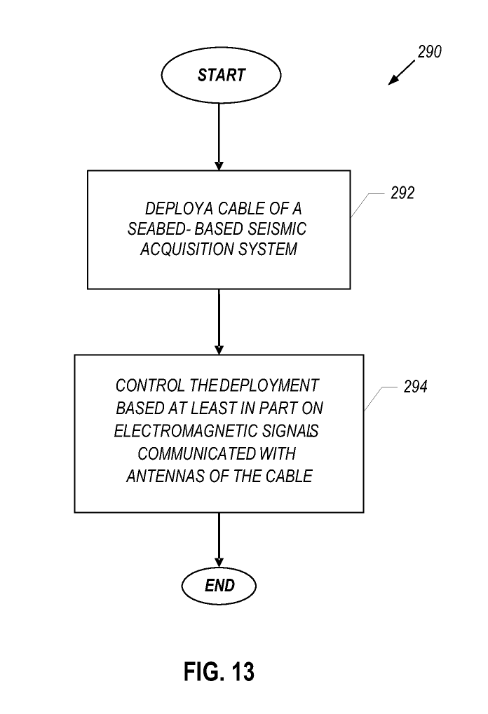

The arrangement depicted in FIG. 13 departs from a conventional arrangement, which uses dropped positions. The dropped position technique entails determining the position of the cable based on measuring the GPS position of the back deck of the vessel and estimating the position at which a particular sensor is dropped to the sea floor. However, using the system 280, errors inherent in these estimations is eliminated, as triangulation may be performed and hence, the cable position on the sea floor 283 may be determined as the cable 282 is being deployed.

Thus, to summarize, a technique 290 that is depicted in FIG. 13 may be used to deploy a seabed cable in accordance with some embodiments of the invention. Referring to FIG. 13, the technique 290 includes deploying (block 292) a cable of a seabed-based seismic acquisition system and controlling (block 294) the deployment based at least in part on electromagnetic signals that are communicated with antennas of the cable.

Other embodiments are contemplated and are within the scope of the appended claims. For example, FIG. 14 depicts a system 300 in accordance with other embodiments of the invention. The system 300 may be used for purposes of conducting an electromagnetic survey. The system 300 includes a towed electromagnetic source 310 and electromagnetic receivers, which are used in the survey and are not depicted in FIG. 14. For purposes of positioning the electromagnetic source 310, one or more electromagnetic antennas, such as electromagnetic antennas 312 that are mounted on a tow line 311 (towed by a source 304), as a non-limiting example, may be used for purposes of positioning the electromagnetic source 310. The antennas 312 may be electrically coupled to one or more receivers or transceivers; and the receivers/transceivers may communicate with each other. In accordance with some embodiments of the invention, the electromagnetic source 310 itself may be the origin of the positioning signal. In other embodiments of the invention, dedicated transmitters may be used for purposes of positioning the electromagnetic source 310.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising:
a towed seismic acquisition system; and
a ranging system adapted to use electromagnetic ranging signals to indicate a location of one or more points on the towed seismic acquisition system.

2. The apparatus of claim 1, wherein
the towed seismic acquisition system comprises a float, a string suspended from the float and a global positioning satellite receiver on the float, and
the ranging system comprises antennas on the float and the string to communicate electromagnetic ranging signals between the antennas to indicate a position on the string relative to a position on the float.

3. The apparatus of claim 2, wherein at least one of the antennas is connected to the float and suspended below a sea surface on which the float is towed.

4. The apparatus of claim 2, wherein at least one of the antennas is connected to the float and suspended above a sea surface on which the float is towed.

5. The apparatus of claim 2, wherein the string comprises a gun string.

6. The apparatus of claim 2, wherein the string comprises a streamer.

7. The apparatus of claim 1, wherein
the string comprises a streamer, and
the ranging system is adapted to use the electromagnetic ranging signals to indicate locations of points along the streamer.

8. The apparatus of claim 7, wherein the string comprises antennas distributed along the length of the streamer, and the antennas use the electromagnetic ranging signals to indicate positions of points along the length of the streamer.

9. The apparatus of claim 7, further comprising:
an acoustic ranging system to indicate positions of points along the streamer;
a float from which the streamer is suspended; and
a global positioning satellite receiver on the float,
wherein the ranging system that is adapted to use electromagnetic signals comprises at least one antenna on the streamer and at least one antenna on the float to communicate electromagnetic signals to indicate the location of at least one position on the streamer.

10. The apparatus of claim 1, wherein
the towed seismic acquisition system comprises a vessel and a string that is towed by the vessel, and
the ranging system includes at least one antenna on the string and at least one antenna on the vessel to communicate electromagnetic signals to indicate the location of at least one position on the streamer.

11. The apparatus of claim 10, wherein the string comprises a source string or a streamer.

12. The apparatus of claim 1, wherein the electromagnetic ranging signals comprise a first electromagnetic ranging signal that propagates above a sea surface and a second electromagnetic ranging signal that propagates below the sea surface, wherein the first electromagnetic ranging signal has a relatively higher frequency than a frequency of the second electromagnetic ranging signal.

13. An apparatus comprising:
a seabed-based seismic acquisition system; and
an electromagnetic positioning system to communicate electromagnetic signals between the seabed-based seismic acquisition system and an autonomous underwater vehicle to position the vehicle relative to the seabed-based seismic acquisition system.

14. The apparatus of claim 13, further comprising:
an electromagnetic data transmission system to communicate electromagnetic signals with the autonomous underwater vehicle to transfer acquired seismic data from nodes of the seabed-based seismic acquisition system to the autonomous underwater vehicle.

15. A method comprising:
towing a seismic acquisition system; and
using electromagnetic ranging signals to indicate a location of one or more points on the seismic acquisition system.

16. The method of claim 15, wherein the using comprises:
communicating electromagnetic ranging signals between an antenna disposed on a float and an antenna disposed on a string suspended from the float.

17. The method of claim 15, wherein the seismic acquisition system comprises a streamer and the using comprises communicating electromagnetic ranging signals to indicate locations of points on the streamer.

18. The method of claim 17, further comprising:
communicating acoustic ranging signals to indicate locations of points on the streamer.

19. The method of claim 15, wherein
the act of towing a seismic acquisition system comprises towing a string with a vessel, and
the act of using the electromagnetic ranging system comprises communicating electromagnetic signals between at least one antenna on the string and at least one antenna on the vessel.

20. The method of claim 19, wherein the string comprises a source string or a streamer.

21. The method of claim 19, further comprising:
steering the string based at least in part on the electromagnetic signals communicated between said at least one antenna on the string and said at least one antenna on the vessel.

22. The method of claim 15, wherein the electromagnetic signals are located in a frequency band from approximately ten to thirty kilohertz.

23. The method of claim 15, wherein the act of using electromagnetic ranging signals comprises:
using a first electromagnetic ranging signal that propagates above a sea surface; and
using a second electromagnetic ranging signal that propagates below the sea surface,
wherein the first electromagnetic ranging signal has a frequency that is relatively higher than a frequency of the second electromagnetic ranging signal.

24. A method comprising:
positioning an autonomous underwater vehicle near a node of a seabed-based seismic acquisition system; and
controlling the positioning based at least in part on an electromagnetic signal communicated between the seabed-based seismic acquisition system and the autonomous underwater vehicle.

25. The method of claim 24, further comprising:
communicating an electromagnetic signal between the autonomous underwater vehicle and the seabed-based seismic acquisition system to transfer acquired seismic data from the node to the autonomous underwater vehicle.

26. A method comprising:
deploying a cable of a seabed-based seismic acquisition system; and
controlling the deployment based at least in part on electromagnetic signals communicated with antennas of the cable.

27. An apparatus comprising:
a cable of seabed-based seismic acquisition system;
antennas disposed along the cable; and
a vessel to control the deployment of the cable on a seabed based at least in part on electromagnetic signals communicated with the antennas.
